(19) United States
(12) Patent Application Publication
(10) Pub. No.: US 2014/0256288 A1
(43) Pub. Date: Sep. 11, 2014

(54) On-Screen Notification Privacy and Confidentiality in Personal Devices

(71) Applicant: INTERNATIONAL BUSINESS MACHINES CORPORATION, Armonk, NY (US)

(72) Inventor: Corville O. Allen, Morrisville, NC (US)

(73) Assignee: INTERNATIONAL BUSINESS MACHINES CORPORATION, Armonk, NY (US)

(21) Appl. No.: 13/794,307

(22) Filed: Mar. 11, 2013

(51) Int. Cl. H04W 12/02

(52) U.S. Cl. CPC H04W 12/02
USPC 455/411

(57) ABSTRACT

An approach is provided conceal notification data at a mobile device, such as a mobile phone. In the approach, a policy of concealing notification data received at a mobile device is provided. A user action is then required prior to displaying the concealed notification data.

### TECHNICAL FIELD

The present disclosure relates to an approach that protects private and confidential data displayed on a personal device such as a mobile phone.

### BACKGROUND OF THE INVENTION

Mobile and personal devices (e.g., smart phones, tablet devices, etc.) are often shared or otherwise passed between users in order to allow others to make telephone calls or retrieve information, e.g., from the Web). These systems usually have a notification system that displays incoming messages from various applications and features. However, in traditional systems, once the owner unlocks the device (e.g., using their password, etc.) the notifications on those machines are easily visible by any user of the system and the notifications are not filtered or masked. In other words, any user of the system is able to view messages and other notifications transmitted to the device by a third party. In most circumstances, the third party (the sender) is unaware that someone other than the owner of the device is currently using the device. One approach to preventing others from viewing such potentially private and confidential information is to simply disable the notification feature on the device. However, simple disabling is generally not a reasonable option as many users find great benefit in being able to quickly and easily send and retrieve notifications, such as provided with text or instant messaging.

### SUMMARY

An approach is provided to conceal notification data at a mobile device, such as a mobile phone. In the approach, a policy of concealing notification data received at a mobile device is provided. A user action is then required prior to displaying the concealed notification data.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various components used in providing privacy and confidentiality with regard to notifications displayed on personal devices;

FIG. 4 is a depiction of a flowchart showing the logic used in setting up personal device notification privacy settings;

FIG. 5 is a depiction of a flowchart showing the logic used in the personal device's reception of notifications after notification privacy settings have been established; and

FIG. 6 is a depiction of a flowchart showing the steps pertaining to the usage of the personal device after notification privacy settings have been established.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

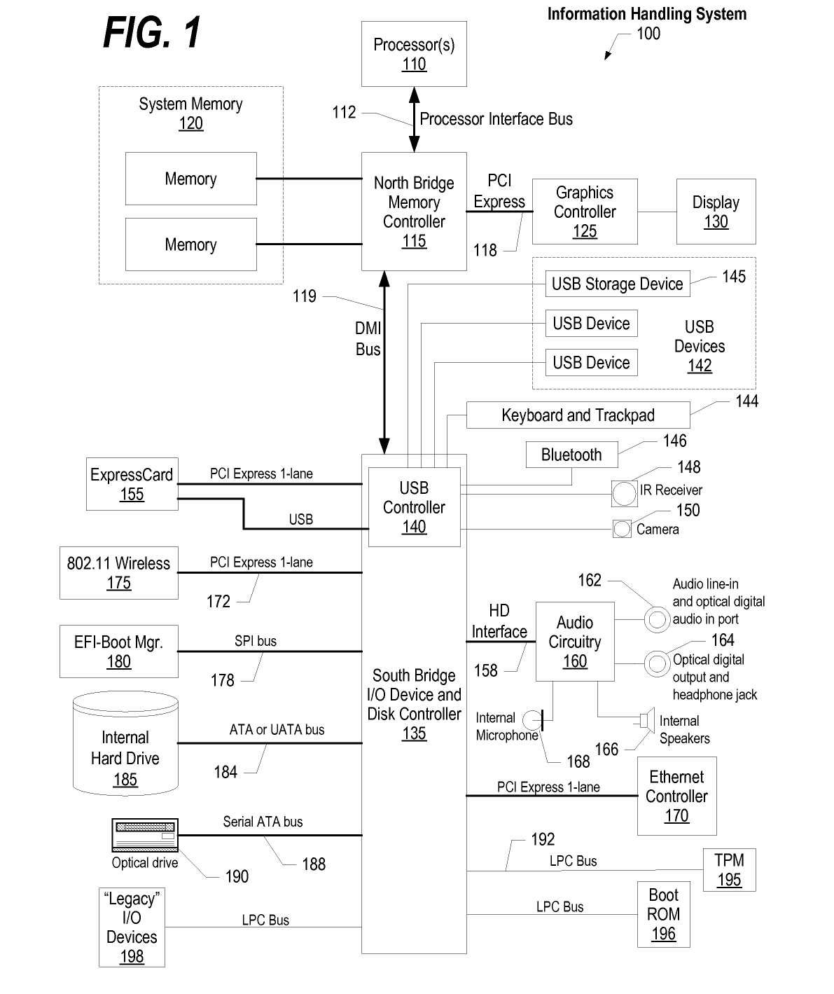

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

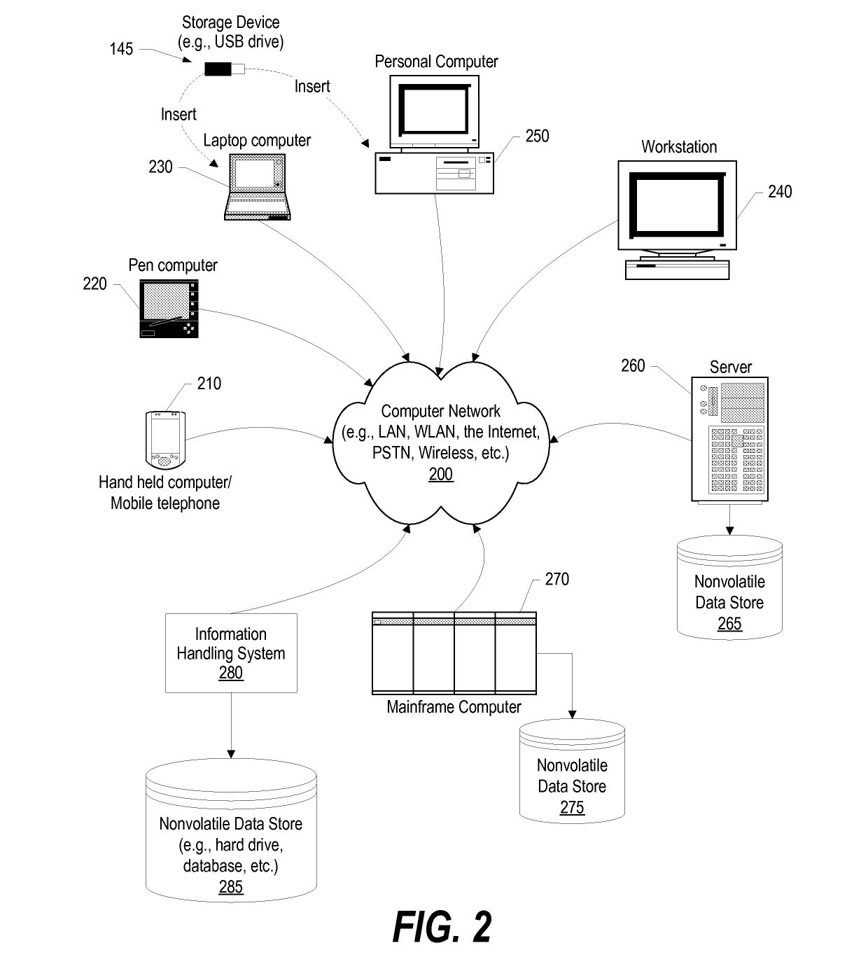

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

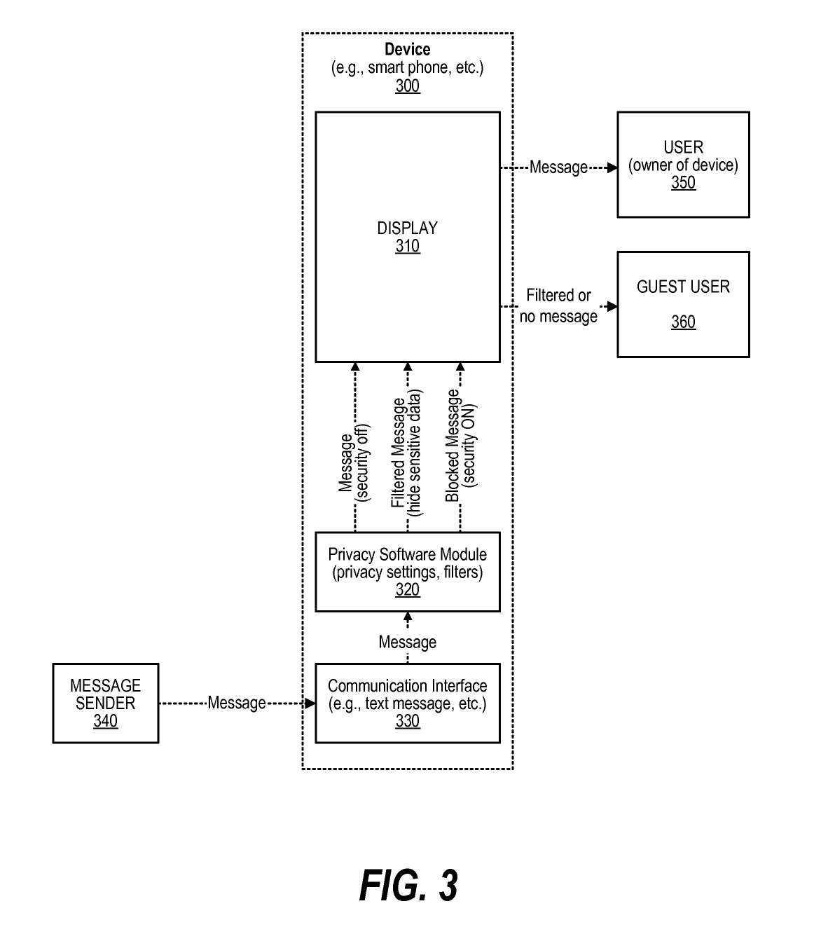

FIGS. 3-6 depict an approach that can be executed on an information handling system, such as a mobile device, and computer network as shown in FIGS. 1-2. An approach is provided to conceal notification data at a mobile device, such as a mobile phone. In the approach, a policy of concealing notification data received at a mobile device is provided. A user action is then required prior to displaying the concealed notification data. The approach utilizes policies defined by the user that prevent certain sensitive information from being shown when included in notification messages, such as electronic mail (email) messages, instant messages (IM), text messages, and a chat messages. The approach provides the ability to conceal, or mask, parts of the notification data, such as names, account identifiers, phone numbers, monetary amounts, as well as user-specified patterns. In this manner, personal, confidential, or private data included in notification data is hidden or otherwise concealed from view on personal devices so that the information is not readily available to any user of the system based on policies and patterns that the owner of the device has designated. The owner then has the option on the notification tab to specify to show the full message, but in one embodiment, is prompted to enter a password.

When a notification is about to be presented on screen a policy is analyzed and the notification text and/or title is concealed and will not be displayed if it meets the criteria specified in the policy. This can also be based on a pattern within the notification text. Examples of policies include: bank account data, phone numbers data, names of people, monetary amounts, and other restricted text that may be defined by the user, etc. The ability to conceal the data based on pattern recognition is to parse the text message, designate the type of message it contains, and only display in the title or the text a portion of the notification data that is not concealed.

For example, if the owner requested a bank balance from his bank, the bank may send notification data such as “Your available balance for account ending in #3456 on Mar. 1, 2013 is $1200.” The policy could be set to conceal monetary amounts, in which case the message that would appear on the display screen would be, “Your available balance for account #3456 on Mar. 1, 2013 is ###############.” The policy could further be set to completely conceal the notification data. FIGS. 3-6 provide further details related to one or more embodiments that conceal notification data at a mobile device, such as a mobile phone.

FIG. 3 is a component diagram showing the various components used in providing privacy and confidentiality with regard to notifications displayed on personal devices. Mobile device 300 includes display screen 310 upon which notification data is displayed. Mobile device 300 includes any form of mobile information handling system including mobile telephones, personal digital assistants (PDAs), smart phones, tablet computer systems, laptop computer systems, and notebook computer systems. Notification data includes any message or data received by mobile device 300 intended for display upon display screen 310, such as electronic mail (email) messages, instant messages (IMs), text messages, and chat messages.

Privacy software module 320 includes privacy policy settings and filters used to control concealment of notification data upon display screen 310. Notification data is received from message sender 340 and received by the mobile device's data communication interface 330 (e.g., electronic mail (email) application, instant message (IM) service, text message service, chat message service, etc.

Module 320 accesses a stored policy of concealing notification data received at mobile device 300. In addition, when the policy is activated, a user action is required by module 320, such as the entering of a password, prior to displaying the concealed notification data on the display screen. In one embodiment, privacy module 320 includes contextual concealment technology that conceals a portion of the received notification data. The portion that is concealed includes a data type such as a name, an account identifier, a phone number, a monetary amount, or a user-specified pattern. When such data type is detected, module 320 conceals the data corresponding to the data type (e.g., concealing any monetary data included in notification data, etc.). In one embodiment, the policy is activated by user 350 performing an act, such as a gesture, on device 300. For example, a gesture using three fingers going from the top of display 310 to the bottom of the display might be used to activate the policy. In this manner, the user can activate the policy before providing the mobile device to guest user 360 (e.g., someone borrowing the mobile device to place a telephone call, search the Internet, etc.). After the policy has been activated, incoming notification data would be concealed according to the policy in place at the device (e.g., context-specific concealment, entire message concealment, etc.). Once guest user 360 returns the mobile device to the owner (user 350), then the user can view notification data that was concealed while guest user was utilizing the device by performing an action (e.g., entering a password, performance of a predetermined sequence of actions, performing a finger gesture on the display surface, etc.). In this manner, the owner of the device (user 350) is able to temporarily lend or provide mobile device 300 to guest users 360 without compromising the owner's privacy due to confidential or other sensitive material that may be included in notification data received at the mobile device.

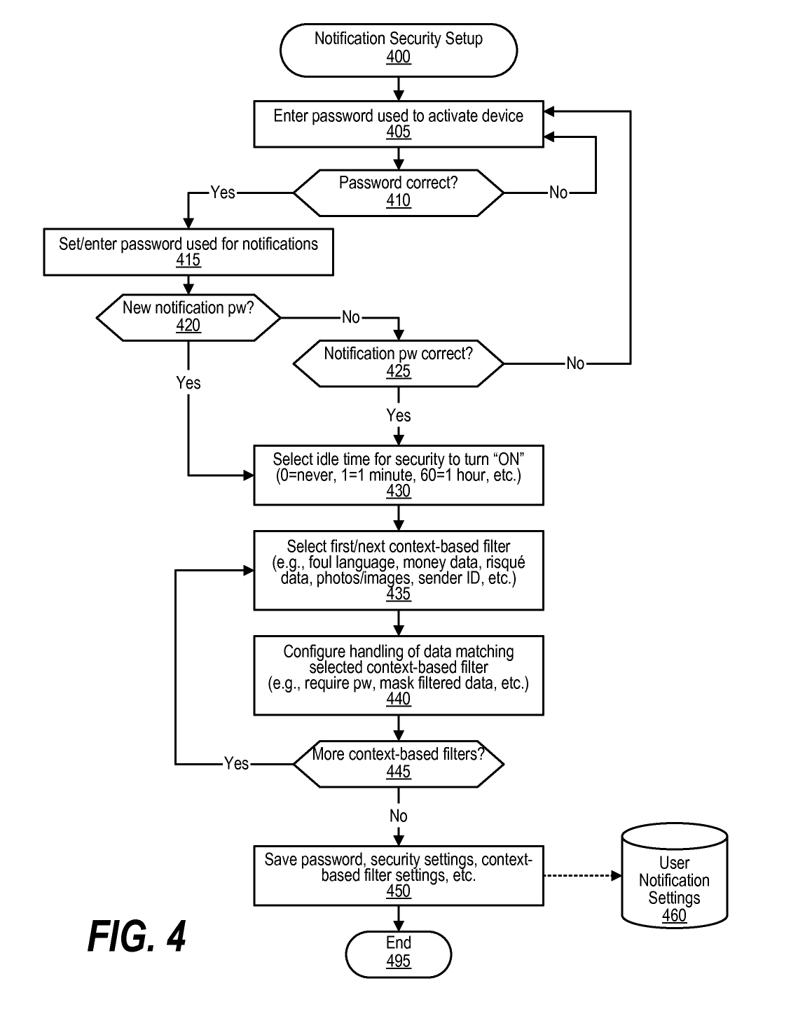

FIG. 4 is a depiction of a flowchart showing the logic used in setting up personal device notification privacy settings. Notification security setup processing commences at 400 whereupon, at step 405, the owner (user) of the mobile device enters a password that is used to activate the device. A decision is made as to whether the password received at the device from the user is correct (decision 410). If the password is incorrect, then decision 410 branches to the “no” branch which continues to loop back to step 405 for re-entry of the password. Once the password is entered correctly, decision 410 branches to the “yes” branch for notification security setup steps.

At step 415, the user enters a second password that is used to receive concealed data from received notification data. A decision is made as to whether this is a new notification password (e.g., the first time the user has used the notification security setup process, etc.) at decision 420. If a notification password has already been setup, then decision 420 branches to the “no” branch whereupon a decision is made as to whether the notification password entered by the user at step 415 is correct (decision 425). If the notification password is incorrect, decision 425 branches to the “no” branch which loops back to lock the device and require entry of both the activation password and then the notification passwords, as described above. On the other hand, if either the notification password was entered correctly (decision 425 branching to the “yes” branch) or it is the first time a notification password has been provided (decision 420 branching to the “yes” branch), then the user provides the desired policy of concealing notification data in steps 430 through 440.

At step 430, the user enters the amount of idle time needed at the mobile device before the policy is activated. In one embodiment, the user can select to never have the policy activated because of inactivity, or can choose a number of minutes of inactivity before the policy is activated. At step 430, the user can enter a context-based filter, such as detection of profane language, monetary data, risqué data, digital images, or other types of data detected in received notification data. At step 440, the user can configure how the policy will handle incoming notification data that matches the selected context-based filter. For example, the user can configure the policy to require the notification password to view the concealed notification data, mask (conceal) the content within the received notification data, etc. A decision is made as to whether the user would like to configure additional context-based filters (decision 445). If the user wishes to configure additional filters, then decision 445 branches to the “yes” branch which loops back to select the next context-based filter and configure how the next selected context-based filter is handled as described above. This looping continues until the user does not wish to configure any more context-based filters, at which point decision 445 branches to the “no” branch whereupon, at step 450, the notification password, policy settings, and context-based filter settings are stored in user notification data store 460. Notification security setup processing thereafter ends at 495.

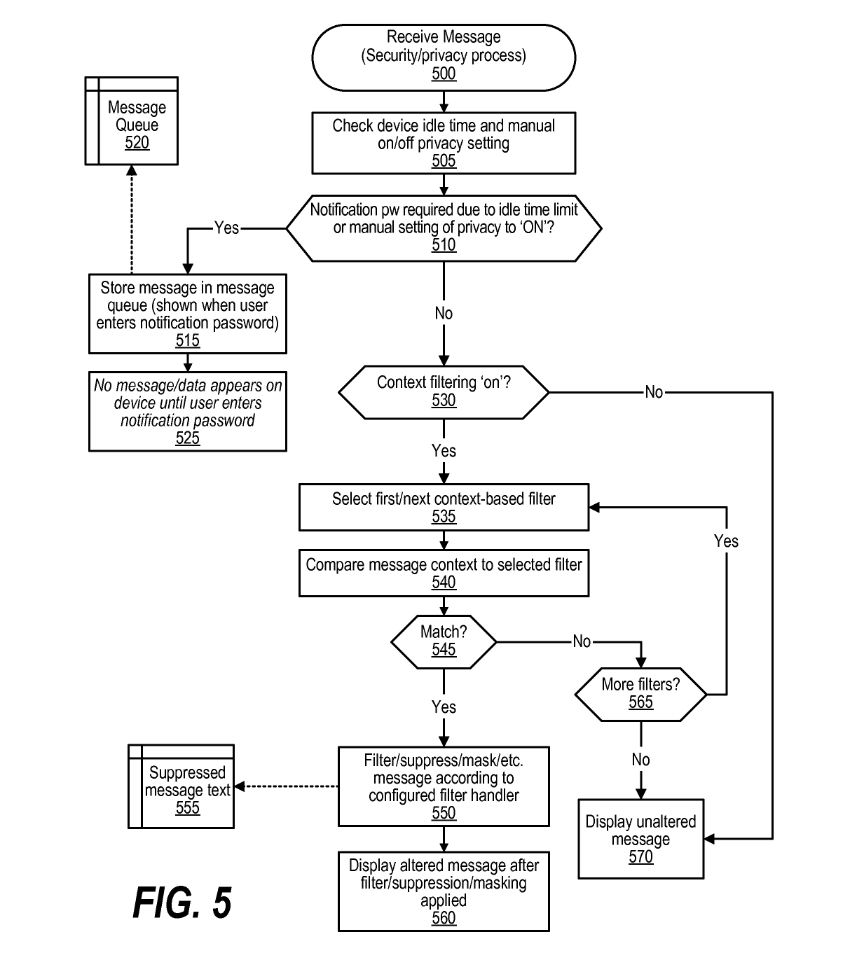

FIG. 5 is a depiction of a flowchart showing the logic used in the personal device's reception of notifications after notification privacy settings have been established. Processing performed by the mobile device commences at 500 when incoming notification data (e.g., an electronic mail (email) message, an instant message (IM), a text message, a chat message, etc.) is received at the device. At step 505, the amount of device idle time is checked along with whether the user manually set activated the policy of concealing notification data. A decision is made as to whether the notification password is required at the device either because the amount of device idle time has exceeded the user's policy limit or because the user has manually activated the policy of concealing notification data (decision 510).

If the notification password is required because of either of these reasons, then decision 510 branches to the “yes” branch whereupon, at step 515, the incoming notification data is stored in message queue 520 and will be shown to the owner (user) of the mobile device upon entry of the notification password. As step 525 illustrates, in one embodiment, no message/data appears on the mobile device's display screen until the user enters the notification password.

Returning to decision 510, if the notification password is not required because of excessive device idle time or because of manual activation of the policy of concealing notification data, then decision 510 branches to the “no” branch for further message reception processing. A decision is made as to whether the user has activated context-based filtering (decision 530). If context-based filtering is active, then decision 530 branches to the “yes” branch whereupon, at step 535, the first context-based filter configured by the user is selected. At step 540, the notification data content (e.g., message text, etc.) is compared with the selected context-based filter. A decision is made as to whether the notification data content matches the selected context-based filter (decision 545). If the notification data content matches the selected context-based filter, then decision 545 branches to the “yes” branch whereupon, at step 550, the text within the notification data that matches the context-based filter is concealed (e.g., masked, etc.) and the concealed notification data is stored in memory area 555. For example, if the notification data is a text message from the user's bank with the user's bank balance and the context-based filter is set to conceal monetary data, then the actual bank balance (e.g., “$1,200”, etc.) is masked (concealed) and the balance figure (e.g., “$1,200”) is stored in memory area 555. At step 560, the altered notification data is displayed on the display screen (e.g., concealing the bank balance, etc.).

Returning to decision 545, if the notification data content does not match the selected context-based filter, then decision 545 branches to the “no” branch whereupon a decision is made as to whether there are additional context-based filters that have been configured (decision 565). If there are additional configured context-based filters, then decision 565 branches to the “yes” branch which loops back to select and process the next context-based filter. This looping continues until either a context-based filter matches the notification data (at which poing decision 545 branches to the “yes” branch as described above), or there are no more configured context-based filters to process. If none of the configured context-based filters match the notification data (decision 565 branching to the “no” branch) or if context filtering is turned off (decision 530 branching to the “no” branch), then the unaltered notification data is displayed on the display screen at step 570.

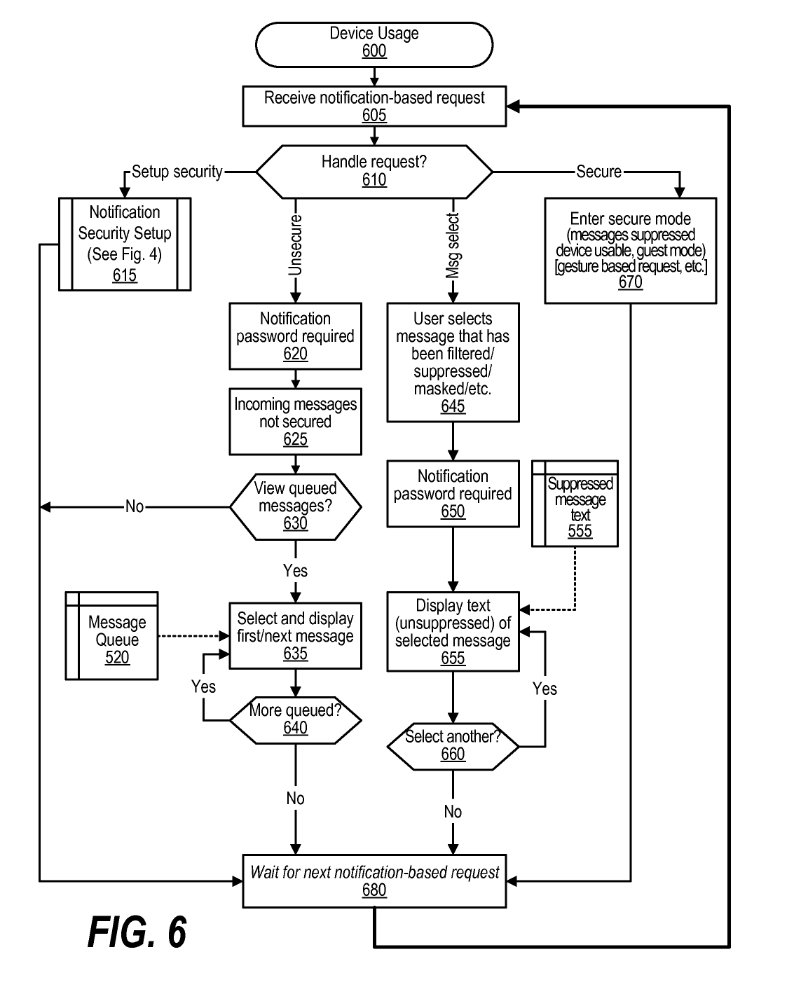

FIG. 6 is a depiction of a flowchart showing the steps pertaining to the usage of the personal device after notification privacy settings have been established. Device usage processing commences at 600 whereupon, at step 605, a notification-based request is received at the mobile device from the user. A decision is made as to how to handle the request at 610. If the request is to setup notification security, then decision 610 branches to “setup security” branch whereupon, at predefined process 615, the notification security setup process is performed (see FIG. 4 and corresponding text for processing details).

On the other hand, if the notification-based request is to deactivate the policy of concealing notification data currently in place at the device so that the full text included in received notification data is visible to the user, then decision 610 branches to the “unsecure” branch for processing. At step 620, the notification password is required before the policy of concealing notification data is deactivated. Once the correct notification password has been entered, at step 625, further notification data received at the mobile device will not be secured and will be displayed on the display screen. In one embodiment, context-based filters will still be in place even after the notification password has been entered. A decision is made as to whether the user wishes to view notification data that was queued while the policy of concealing notification data was active (decision 630). If the user does not wish to viewed such queued notification data, then decision 630 branches to the “no” branch and, at step 680, the device waits for entry of the next notification-based request by the user. On the other hand, if the user requests to viewed queued notification data, then decision 630 branches to the “yes” branch whereupon, at step 635, the first notification data is selected from message queue 520 and displayed on the display screen. A decision is made as to whether there is more queued notification data (decision 640). If there is more queued notification data, then decision 640 branches to the “yes” branch which loops back to select and display the next notification data. This looping continues until all of the queued notification data has been selected and displayed at the mobile device, at which point decision 640 branches to the “no” branch whereupon, at step 680 the device waits for entry of the next notification-based request by the user.

Returning to decision 610, if the request received from the user was selection of a displayed notification data that had a portion of the data concealed due to a context-based filter, then decision 610 branches to the “msg select” branch. At step 645, the user selects a notification data (e.g., message, etc.) that has been filtered/suppressed/masked/etc. due to a context-based filter. At step 650 the notification password is required before the concealed portion of the notification data is revealed. At step 655, the complete notification data (e.g., concealed bank balance, etc.) corresponding to the notification data selected by the user is retrieved from memory area 555 and displayed to the user on the mobile device's display screen. A decision is made as to whether the user wishes to select another notification data that has been altered to conceal a portion of the notification data due to a context-based filter (decision 660). If the user selects another such notification data, then decision 660 loops back to retrieve the concealed text of the selected notification data from memory area 555 and displays the complete message on the mobile device's display screen. When the user no longer wishes to select more notification data, then decision 660 branches to the “no” branch whereupon at step 680 the device waits for entry of the next notification-based request by the user.

Returning to decision 610, if the request received from the user was to manually activate the policy of concealing notification data, then decision 610 branches to the “secure” branch whereupon, at step 670, the policy is activated and incoming notification data are concealed. At this point, the device is in a usable “guest mode” so that a guest user can use the mobile device without private notification data being displayed on the device's display screen. In one embodiment, the secure mode is entered by using a gesture, such as by using three fingers to swipe the surface of the display from the top of the display to the bottom of the display. At step 680 the device waits for entry of the next notification-based request by the user as described above.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of protecting on-screen notifications on a mobile device, the method, implemented by an information handling system, comprising:
providing a policy of concealing notification data received at a mobile device;
displaying data on the mobile device, wherein at least some notification data received at the mobile device is concealed according to the policy; and
requiring a user action prior to displaying the concealed notification data on the mobile device.

2. The method of claim 1 wherein the policy is activated in response to a user input received at the mobile device.

3. The method of claim 1 further comprising:
concealing a portion of the received notification data, wherein the portion includes a data type that is selected from the group consisting of a name, an account identifier, a phone number, a monetary amount, and a user-specified pattern.

4. The method of claim 1 wherein the mobile device is selected from the group consisting of a mobile telephone, a personal digital assistant (PDA), a smart phone, a tablet computer system, a laptop computer system, and a notebook computer system.

5. The method of claim 1 wherein the notification data is selected from the group consisting of an electronic mail (email) message, an instant message (IM), a text message, and a chat message.

6. The method of claim 1 wherein the user action is selected from the group consisting of a password entry, performance of a predetermined sequence of actions, and a finger gesture performed on a display surface of the mobile device.

7. The method of claim 1 further comprising:
selecting an idle time period, wherein the policy of concealing the notification data is entered after the mobile device is unused for the idle time period;
selecting a plurality of context-based filters, wherein the policy of concealing the notification is entered upon detection of the notification data that matches one of the context-based filter, and wherein the context-based filters are selected from the group consisting of profane language, monetary data, risqué data, digital images, and a sender identifier; and
selecting a concealment handling technique corresponding to the policy, wherein the concealment handling technique is selected from the group consisting of requiring a password to view the notification data, and masking a portion of the notification data.

8. An information handling system comprising:
a plurality of processors;
a memory coupled to at least one of the processors;
a set of instructions stored in the memory and executed by at least one of the processors to protect on-screen notifications, wherein the set of instructions perform actions of:
providing a policy of concealing notification data received at a mobile device;
displaying data on the mobile device, wherein at least some notification data received at the mobile device is concealed according to the policy; and
requiring a user action prior to displaying the concealed notification data on the mobile device.

9. The information handling system of claim 8 wherein the policy is activated in response to a user input received at the mobile device.

10. The information handling system of claim 8 wherein the actions further comprise:
concealing a portion of the received notification data, wherein the portion includes a data type that is selected from the group consisting of a name, an account identifier, a phone number, a monetary amount, and a user-specified pattern.

11. The information handling system of claim 8 wherein the mobile device is selected from the group consisting of a mobile telephone, a personal digital assistant (PDA), a smart phone, a tablet computer system, a laptop computer system, and a notebook computer system.

12. The information handling system of claim 8 wherein the notification data is selected from the group consisting of an electronic mail (email) message, an instant message (IM), a text message, and a chat message.

13. The information handling system of claim 8 wherein the user action is selected from the group consisting of a password entry, performance of a predetermined sequence of actions, and a finger gesture performed on a display surface of the mobile device.

14. The information handling system of claim 8 further wherein the actions further comprise:
selecting an idle time period, wherein the policy of concealing the notification data is entered after the mobile device is unused for the idle time period;
selecting a plurality of context-based filters, wherein the policy of concealing the notification is entered upon detection of the notification data that matches one of the context-based filter, and wherein the context-based filters are selected from the group consisting of profane language, monetary data, risqué data, digital images, and a sender identifier; and
selecting a concealment handling technique corresponding to the policy, wherein the concealment handling technique is selected from the group consisting of requiring a password to view the notification data, and masking a portion of the notification data.

15. A computer program product stored in a computer readable medium, comprising computer instructions that, when executed by an information handling system, causes the information handling system to perform actions comprising:
providing a policy of concealing notification data received at a mobile device;
displaying data on the mobile device, wherein at least some notification data received at the mobile device is concealed according to the policy; and
requiring a user action prior to displaying the concealed notification data on the mobile device.

16. The computer program product of claim 15 wherein the policy is activated in response to a user input received at the mobile device.

17. The computer program product of claim 15 further comprising:
concealing a portion of the received notification data, wherein the portion includes a data type that is selected from the group consisting of a name, an account identifier, a phone number, a monetary amount, and a user-specified pattern.

18. The computer program product of claim 15 wherein the notification data is selected from the group consisting of an electronic mail (email) message, an instant message (IM), a text message, and a chat message.

19. The computer program product of claim 15 wherein the user action is selected from the group consisting of a password entry, performance of a predetermined sequence of actions, and a finger gesture performed on a display surface of the mobile device.

20. The computer program product of claim 15 further comprising:
selecting an idle time period, wherein the policy of concealing the notification data is entered after the mobile device is unused for the idle time period;
selecting a plurality of context-based filters, wherein the policy of concealing the notification is entered upon detection of the notification data that matches one of the context-based filter, and wherein the context-based filters are selected from the group consisting of profane language, monetary data, risqué data, digital images, and a sender identifier; and
selecting a concealment handling technique corresponding to the policy, wherein the concealment handling technique is selected from the group consisting of requiring a password to view the notification data, and masking a portion of the notification data.
performing an action based on the identified confidentiality level, the sender, and the plurality of receivers.
